(19) United States
(12) Patent Application Publication
(10) Pub. No.: US 2026/0058926 A1
(43) Pub. Date: Feb. 26, 2026

(54) MESSAGE ANCHORING

(71) Applicant: The Sunnai Marali Company Inc., Sacramento, CA (US)

(72) Inventors: Eric Kyungmo Hahn, Honolulu, HI (US); Geoffrey Sungjun Hahn, Honolulu, HI (US)

(21) Appl. No.: 19/310,761

(22) Filed: Aug. 26, 2025

Related U.S. Application Data
(60) Provisional application No. 63/687,262, filed on Aug. 26, 2024.

(51) Int. Cl. H04L 51/216; H04L 51/04

(52) U.S. Cl. CPC H04L 51/216; H04L 51/04

(57) ABSTRACT

A message recipient may receive a first text message from a message sender in a chat room between the message sender and a message recipient on a mobile application executing on a smartphone associated with the message recipient. A message recipient may detect a first anchoring user input from the message recipient with respect to the first text message indicating that the first text message is to be anchored. A message recipient may anchor the first text message such that the first text message is displayed on a display screen of the smartphone in response to the message recipient selecting the chat room between the message sender and the message recipient from a list of chat rooms on the mobile application.

### CROSS-REFERENCE TO RELATED APPLICATIONS

The present application claims the benefit of U.S. Provisional Application No. 63/687,262, filed Aug. 26, 2024, which is hereby incorporated by reference in its entirety.

### BACKGROUND

### Field

The present disclosure generally relates to systems, methods, and devices for text message anchoring.

### SUMMARY

Various embodiments described herein relate to systems, methods, and devices for text message anchoring. The present disclosure generally relates to a method of allowing a user to anchor a text message so that it can be used as a fleeting, non-disruptive recurring self-reminder to the user.

In particular, in some embodiments, described herein is a method for anchoring a received message. The method comprises receiving a first text message from a message sender in a chat room between the message sender and a message recipient on a mobile application executing on a smartphone associated with the message recipient; detecting a first anchoring user input from the message recipient with respect to the first text message indicating that the first text message is to be anchored; anchoring the first text message such that the first text message is displayed on a display screen of the smartphone in response to the message recipient selecting the chat room between the message sender and the message recipient from a list of chat rooms on the mobile application; in response to detecting a first selecting user input from the message recipient selecting the chat room with the message sender and the message recipient from the list of chat rooms on the mobile application, causing the first text message to be displayed on a region of the display screen; and in response to detecting a subsequent user input from the message recipient subsequent to or immediately subsequent to the first selecting user input, causing (i) the first text message to be removed from the region of the display screen and (ii) at least a portion of another text message between the message sender and the message recipient to be displayed in the region of the display screen from the first text message was removed.

In other embodiments, described herein is a method for sending a message with an anchor. The method comprises sending a first text message from a message sender in a chat room between the message sender and a message recipient on a mobile application executing on a smartphone associated with the message sender; detecting a first anchoring user input, from the message sender with respect to the first text message to be sent, indicating that the first text message is to be anchored after being sent; anchoring the first text message such that the first text message is displayed on a display screen of the smartphone in response to the message sender selecting the chat room between the message sender and the message recipient from a list of chat rooms on the mobile application; in response to detecting a first selecting user input from the message sender selecting the chat room with the message sender and the message recipient from the list of chat rooms on the mobile application, causing the first text message to be displayed on a region of the display screen, and in response to detecting a subsequent user input from the message sender subsequent to or immediately subsequent to the first selecting user input, causing (i) the first text message to be removed from the region of the display screen and (ii) at least a portion of another text message between the message sender and the message recipient to be displayed in the region of the display screen from the first text message was removed.

In yet other embodiments, described herein is a system for anchoring a received message. The system comprises a sender device associated with a message sender; a recipient device associated with a message recipient, configured at least to: receive a first text message from a message sender in a chat room between the message sender and the message recipient on a mobile application executing on the device associated with the message recipient; detect a first anchoring user input from the message recipient with respect to the first text message indicating that the first text message is to be anchored; anchor the first text message such that the first text message is displayed on a display screen of the device in response to the message recipient selecting the chat room between the message sender and the message recipient from a list of chat rooms on the mobile application; in response to detecting a first selecting user input from the message recipient selecting the chat room with the message sender and the message recipient from the list of chat rooms on the mobile application, cause the first text message to be displayed on a region of the display screen; and in response to detecting a subsequent user input from the message recipient subsequent to or immediately subsequent to the first selecting user input, cause (i) the first text message to be removed from the region of the display screen and (ii) at least a portion of another text message between the message sender and the message recipient to be displayed in the region of the display screen from the first text message was removed.

For purposes of this summary, certain aspects, advantages, and novel features of the invention are described herein. It is to be understood that not necessarily all such advantages may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

All of these embodiments are intended to be within the scope of the invention herein disclosed. These and other embodiments will become readily apparent to those skilled in the art from the following detailed description having reference to the attached figures, the invention not being limited to any particular disclosed embodiment(s).

### BRIEF DESCRIPTION OF THE DRAWINGS

Features of examples of the present disclosure will become apparent by reference to the following detailed description and drawings, in which like reference numerals correspond to similar, though perhaps not identical, components. For the sake of brevity, reference numerals or features having a previously described function may or may not be described in connection with other drawings in which they appear.

FIGS. 1A-1F illustrate flow diagrams according to embodiments of methods for text message anchoring of the present disclosure.

FIGS. 2A-2D illustrate diagrams depicting embodiments of systems configured for implementing one or more embodiments of methods for text message anchoring of the present disclosure.

FIGS. 3A-3B illustrate diagrams depicting embodiments of a system configured for implementing one or more embodiments of methods for text message anchoring of the present disclosure.

FIG. 4 is a block diagram depicting an embodiment(s) of a system configured for implementing one or more embodiments of systems, devices, and methods for text message anchoring.

### DETAILED DESCRIPTION OF THE PREFERRED EMBODIMENT

The detailed description set forth below in connection with the drawings is intended as a description of various configurations and is not intended to represent the only configurations in which the concepts described herein may be practiced. The detailed description include specific details for the purpose of providing a thorough understanding of various concepts. However, it will be apparent to those skilled in the art that these concepts may be practiced without these specific details.

All patents, applications, published applications and other publications referred to herein are incorporated herein by reference to the referenced material and in their entireties. If a term or phrase is used herein in a way that is contrary to or otherwise inconsistent with a definition set forth in the patents, applications, published applications and other publications that are herein incorporated by reference, the use herein prevails over the definition that is incorporated herein by reference.

### Definitions

All technical and scientific terms used herein have the same meaning as commonly understood to one of ordinary skill in the art to which this disclosure belongs unless clearly indicated otherwise.

As used herein, the singular forms “a”, “and”, and “the” include plural referents unless the context clearly dictates otherwise. Thus, for example, reference to “a sequence” may include a plurality of such sequences, and so forth.

The terms comprising, including, containing and various forms of these terms are synonymous with each other and are meant to be equally broad. Moreover, unless explicitly stated to the contrary, examples comprising, including, or having an element or a plurality of elements having a particular property may include additional elements, whether or not the additional elements have that property.

As used herein, the term “anchoring” refers to a technology which allows a specific item/object to be displayed in a particular region of a display screen of a point end. In particular, in some embodiments, “anchoring text message” may refer to a technology which allows a particular text message, either received from others or sent by a user, to be pinned/fixed in a specific region of a display screen of a point end. The “anchored” message may refer to the message as if it were weighted that don't float away off the screen as a normal message (e.g., as new messages arrive and are sent). In other contexts in which the latest messages are displayed at the top, the anchored messages may appear at the top instead of at the bottom (e.g., in email applications) and thus anchored to the top.

### INTRODUCTION

Aspects of the present disclosure relate generally to communication systems, devices, and methods. In particular, in some embodiments, the present disclosure relates to communication systems, devices, and methods for text message anchoring.

People send each other text messages on their smartphones, and important messages can get lost. This disclosure allows a user to anchor a specific message such that the next time the user opens the text messaging app, the anchored message appears at a key area of interest or in the most recent area in a chat room, usually the bottom of the display screen, thereby reminding the user of the anchored message. For example, the user may wish to anchor a text message from his dad asking her to pick him up at the airport at 2:30 pm next Saturday. As another example, the user may wish to anchor a kind message from a family member or a friend that she wants to remember and does not want to get buried in all the other messages. The user can anchor such a message as soon as she receives the message so that she will be reminded the next time she opens the app or the next time she enters the chat screen with the sender of the message. The anchored message predictably appears every time a user enters the chatroom to serve as a reminder, and it may move out of the way from its anchored location (e.g., the very bottom of a chatroom screen) when needed or as one or more user inputs are received (e.g., user starts typing, user taps the anchored message, user selects and unanchors the message, etc.). Another benefit may be that the anchored messages may eliminate the need for users to search for or to remember important messages.

As an alternative way to remind herself, the user could create a calendar appointment, which involves many more steps and can only remind the user at a specific time (e.g., 1 day, 30 minutes, or 5 minutes before the appointment). In contrast, it takes just 1-2 steps to anchor a given message, so the user has a reduced risk of being distracted while trying to anchor the message and forgetting to anchor the message. Also, creating a calendar appointment may not be appropriate if the message is not associated with a specific date and time (e.g., a compliment from a colleague). However, if the compliment is anchored, the user can be reminded of the compliment she received from the colleague every time she chats with the colleague.

As yet another alternative, she may be able to “pin” the message to keep the message displayed every time she chats with her dad. However, a pinned message is typically static and takes up valuable screen space unless and until the message is unpinned. To the contrary, an anchored message according to this disclosure would be temporarily displayed when the user opens the app or enters the specific chat room (e.g., the one with the person who sent the anchored message) and disappear as soon as the user interacts with the app (e.g., begins typing, scrolls through the message history, etc.). Also, a pinned message may be displayed for all the chat room participants, whereas an anchored message is displayed only for the user anchoring the message.

### SUMMARY

In some embodiments, described herein is a method for anchoring a received message. The method comprises receiving a first text message from a message sender in a chat room between the message sender and a message recipient on a mobile application executing on a smartphone associated with the message recipient; detecting a first anchoring user input from the message recipient with respect to the first text message indicating that the first text message is to be anchored; anchoring the first text message such that the first text message is displayed on a display screen of the smartphone in response to the message recipient selecting the chat room between the message sender and the message recipient from a list of chat rooms on the mobile application; in response to detecting a first selecting user input from the message recipient selecting the chat room with the message sender and the message recipient from the list of chat rooms on the mobile application, causing the first text message to be displayed on a region of the display screen; and in response to detecting a subsequent user input from the message recipient subsequent to or immediately subsequent to the first selecting user input, causing (i) the first text message to be removed from the region of the display screen and (ii) at least a portion of another text message between the message sender and the message recipient to be displayed in the region of the display screen from the first text message was removed.

In other embodiments, described herein is a method for sending a message with an anchor. The method comprises sending a first text message from a message sender in a chat room between the message sender and a message recipient on a mobile application executing on a smartphone associated with the message sender; detecting a first anchoring user input, from the message sender with respect to the first text message to be sent, indicating that the first text message is to be anchored after being sent; anchoring the first text message such that the first text message is displayed on a display screen of the smartphone in response to the message sender selecting the chat room between the message sender and the message recipient from a list of chat rooms on the mobile application; in response to detecting a first selecting user input from the message sender selecting the chat room with the message sender and the message recipient from the list of chat rooms on the mobile application, causing the first text message to be displayed on a region of the display screen, and in response to detecting a subsequent user input from the message sender subsequent to or immediately subsequent to the first selecting user input, causing (i) the first text message to be removed from the region of the display screen and (ii) at least a portion of another text message between the message sender and the message recipient to be displayed in the region of the display screen from the first text message was removed.

In yet other embodiments, described herein is a system for anchoring a received message. The system comprises a sender device associated with a message sender; a recipient device associated with a message recipient, configured at least to: receive a first text message from a message sender in a chat room between the message sender and the message recipient on a mobile application executing on the device associated with the message recipient; detect a first anchoring user input from the message recipient with respect to the first text message indicating that the first text message is to be anchored; anchor the first text message such that the first text message is displayed on a display screen of the device in response to the message recipient selecting the chat room between the message sender and the message recipient from a list of chat rooms on the mobile application; in response to detecting a first selecting user input from the message recipient selecting the chat room with the message sender and the message recipient from the list of chat rooms on the mobile application, cause the first text message to be displayed on a region of the display screen; and in response to detecting a subsequent user input from the message recipient subsequent to or immediately subsequent to the first selecting user input, cause (i) the first text message to be removed from the region of the display screen and (ii) at least a portion of another text message between the message sender and the message recipient to be displayed in the region of the display screen from the first text message was removed.

### Text Message Anchoring

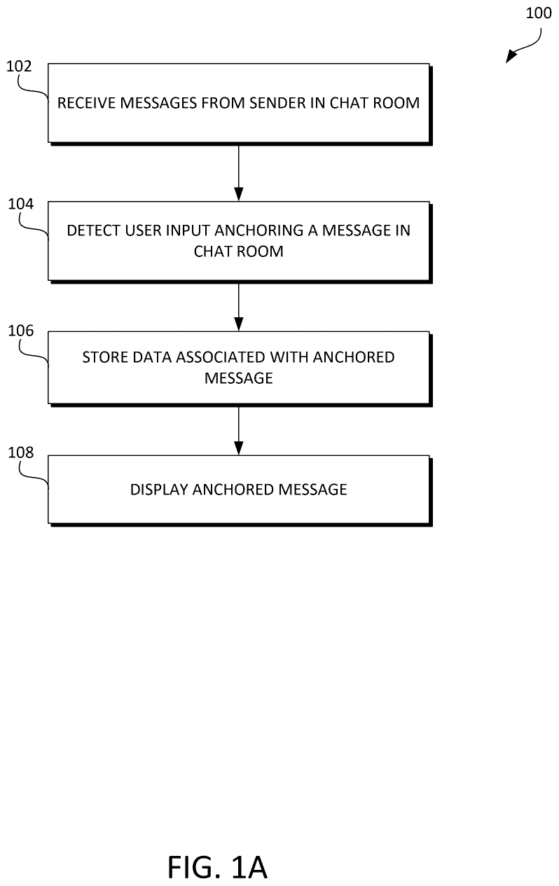

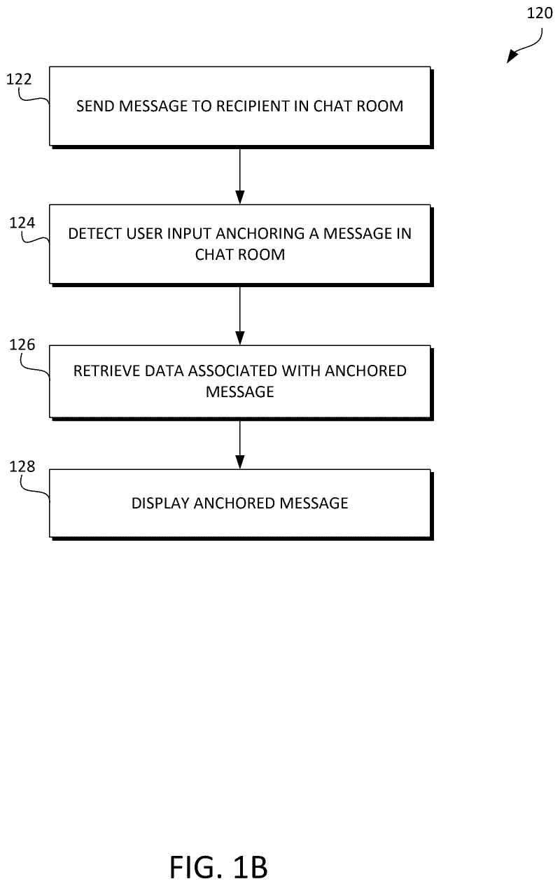

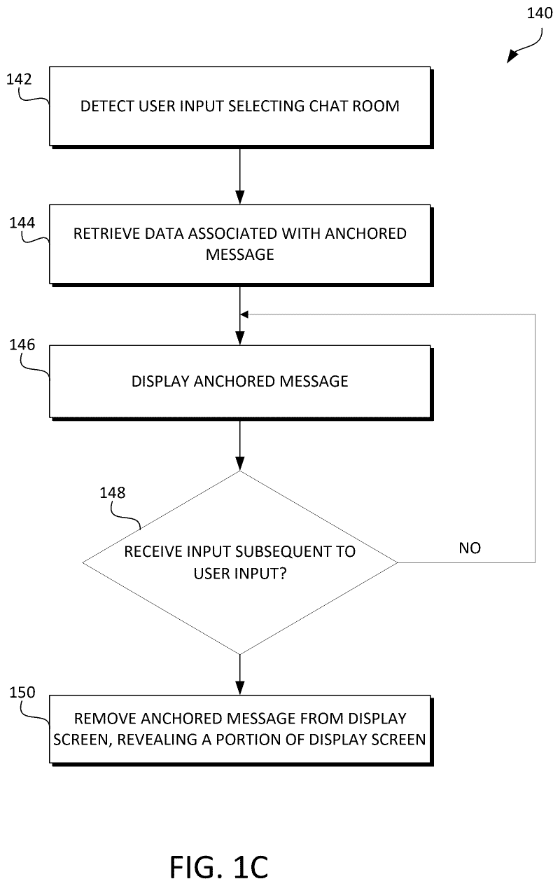

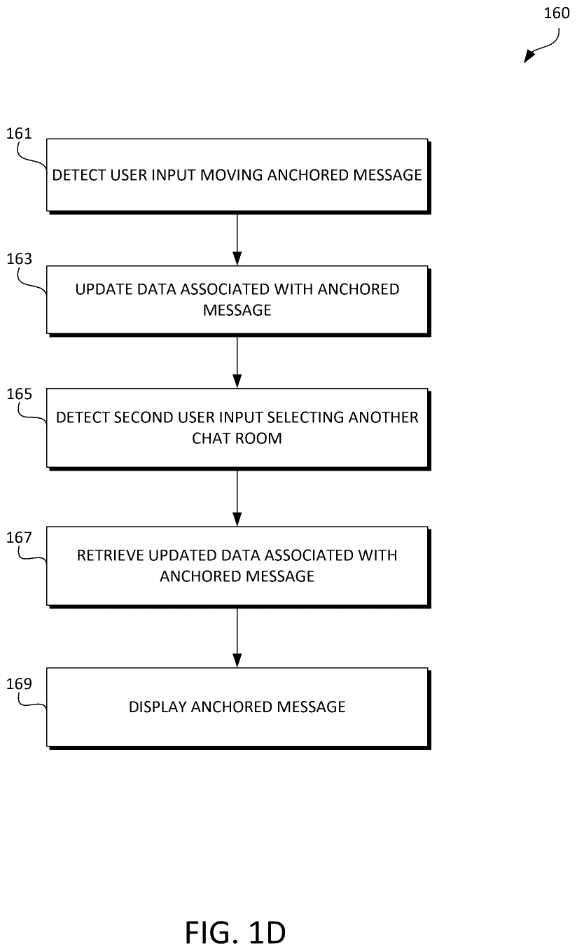

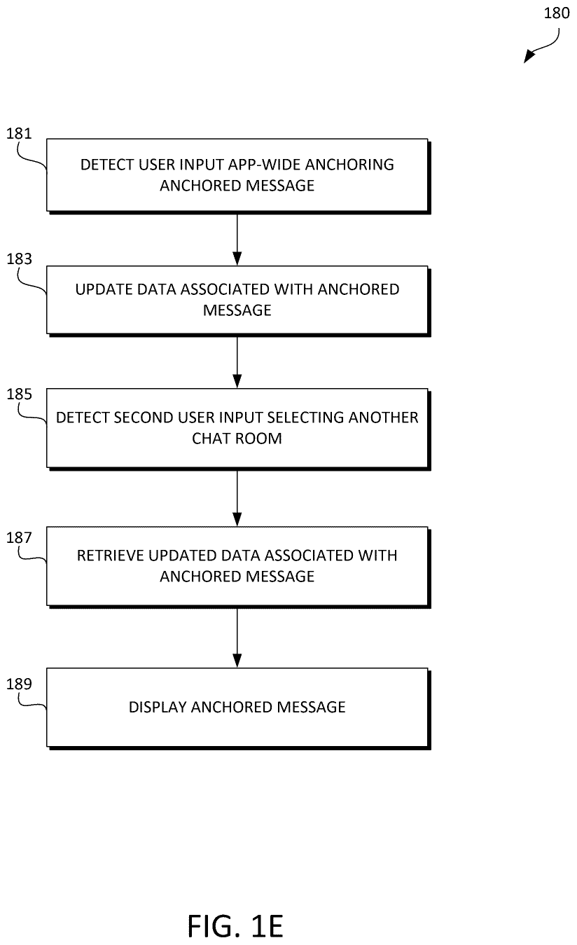

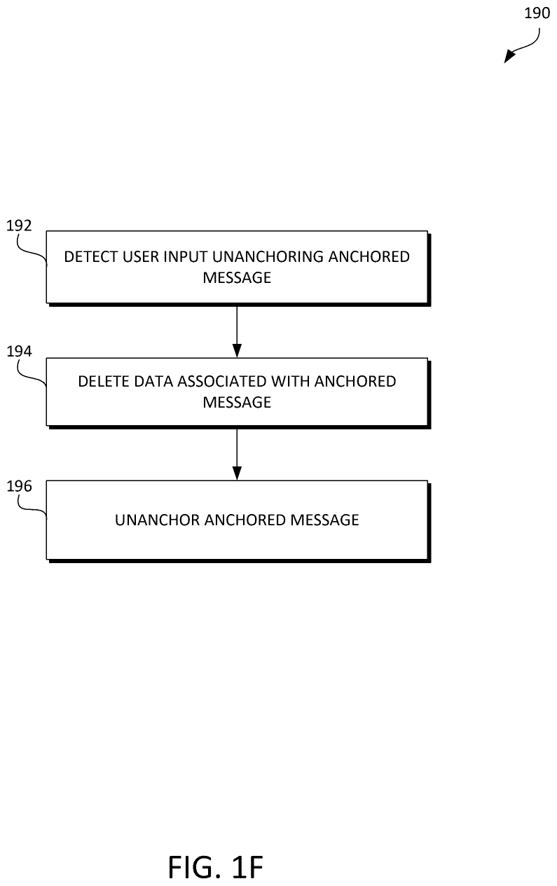

FIG. 1A depicts a flow diagram of a method 100 for text message anchoring, more specifically for receiving user input to anchor a text message in a chat room on a mobile application. The method 100 starts at step 102 when a user receives a text message from a sender in a chat room on a mobile application on the user's smartphone. For example, the user may begin texting with a friend by opening her text messaging app on her smartphone and selecting her friend's name from the list of chats. When she types and presses ‘send’, the message may be transmitted to her friend's smartphone and also be displayed on the display screen of her smartphone. When her friend types a message on his text messaging app and presses ‘send’, the message may be received by her smartphone and displayed on the display screen of her smartphone.

At step 104, the mobile application detects user input indicating that a text message is to be anchored. For example, the user may tap on the message and select ‘anchor’ from a dropdown menu, perform a long press on the message, swipe in a direction (such as left, right, up, or down) on the message, double tap on the message, or perform any combination of these. One advantage of this step is that the user can create a non-disruptive future reminder for herself in a simple one-step or two-step action without having to navigate away from the chat room or the mobile application. This may allow the user to continue the text conversation with minimal interruption.

Upon receiving the user's instruction to anchor the message, data relating to the anchored message is stored at step 106. For example, the data may be stored on the smartphone, the server, or both. The data may include but is not limited to the content of the message, the chat room selected, the message sender, the date/time the message was sent, the date/time the message was received, a message identifier (ID) associated with the message, and the like. For example, the user may have selected her friend's name, Bob, from the list of chats on a mobile messaging app to begin conversing with Bob. While conversing with Bob, she may have just received a kind message from Bob that she does not want to be buried under later messages or disappear far off the screen over later messages. The user may select Bob's kind message to be anchored so that she is reminded of the kind message every time she converses with Bob, or so that she does not have to scroll up to view it each time she wants to find the message. The smartphone and/or the server can store the fact that the message has been anchored by the user. The smartphone and/or the server may store data relating to the anchored message, including the contents of the kind message, the particular chat room between the user and Bob that the user selected, the fact that Bob was the message sender, the fact that the message was sent on Jul. 11, 2024 at 11:15 am, and the like.

As will be illustrated in detail in conjunction with other figures, in some embodiments, a sender can anchor a message that he or she sent. In some embodiments, a recipient can anchor a message that he or she received. In some embodiments, a user can anchor a message that he or she sent or received. In some embodiments, a message is anchored (e.g., configured to operate as a future reminder) only for the user anchoring the message. In some embodiments, a message is anchored (e.g., configured to operate as a future reminder) for both the user anchoring the message and the other user with whom the anchoring user is conversing. In some embodiments, a message is anchored (e.g., configured to operate as a future reminder) only for the other user with whom the anchoring user is conversing.

At step 108, the anchored message is then displayed on a portion of the screen. In some embodiments, the portion may be a prominent portion of the screen (e.g., center, top, bottom, etc.) such that the anchored message serves as a clear reminder to the user of the contents of the anchored message.

As will be illustrated in detail in conjunction with other figures, in some embodiments, the display of the anchored message occurs in response to the user opening a specific chat room (e.g., the chat room with the user who sent the anchored message), such that the anchored message is anchored in a contact-specific manner or a chat-room-specific manner, where the trigger is the opening of the chat room where the anchored message was sent or received. In other embodiments, the display of the anchored message occurs in response to the user launching the text messaging app (instead of the user selecting a chat room), such that the anchored message is anchored in an app-wide manner, where the trigger is the opening of the app. In yet other embodiments, the display of the anchored message occurs in response to the user opening a chat room (e.g., any chat room regardless of who sent the anchored message), such that the anchored message is anchored in an application-wide manner, where the trigger is the opening of one of the chat rooms.

In some embodiments, an anchored message displayed on the screen stays in the same screen location as new user inputs are received and/or new messages are sent or received. In other embodiments, an anchored message displayed on the screen is removed as new user inputs are received and/or new messages are sent or received. In yet other embodiments, an anchored message displayed on the screen moves to a different location removed as new user inputs are received and/or new messages are sent or received.

If there are multiple anchored messages, they may be displayed simultaneously or in sequence (e.g., such that the user can swipe/scroll through them). In some embodiments of the present disclosure, the user may also reorder the multiple anchored messages by another user input, e.g. tapping on one anchored message and select ‘reorder’ from a dropdown menu, performing a long press on the message, swiping in a direction (such as left, right, up, or down) on the message, double tapping on the message, or performing any combination of these.

FIG. 1B depicts a flow diagram of a method 120 for text message anchoring, more specifically for receiving user input to anchor a text message in a chat room on a mobile application. The method 120 starts at step 122 when a user sends a text message to a recipient in a chat room on a mobile application on the user's smartphone. For example, the user may begin texting with a friend by opening her text messaging app on her smartphone and selecting her friend's name from the list of chats. When she types and presses ‘send,’ the message may be transmitted to her friend's smartphone and also be displayed on the display screen of her smartphone. When her friend types a message on his text messaging app and presses ‘send’, the message may be received by her smartphone and displayed on the display screen of her smartphone.

At step 124, the mobile application detects user input indicating that the text message is to be anchored. In some embodiments, when the user preforms a long press on ‘send’ button, the mobile application may pop up an ‘anchor’ menu and the user may select ‘anchor’ from the menu before the message is sent out. In some embodiments, when the user long-presses the ‘send’ button, the mobile application may cause the send button to depict an ‘anchor’ and the user may tap the ‘anchor.’ In some embodiments, the user may perform a press, either short, normal, or long, on the input field or the message to be sent, swipe in a direction (such as left, right, up, or down) on the input field or the message to be sent, double tap on the input field or the message to be sent, or perform any combination of these. In some embodiments, the user may perform any of these or any combination of these to cause the mobile application to pop up an ‘anchor’ menu. The user may select ‘anchor’ from the menu. One advantage of this step is that the user can create a non-disruptive future reminder for herself in a simple one-step or two-step action without having to navigate away from the chat room or the mobile application. This may allow the user to continue the text conversation with minimal interruption.

Upon receiving the user's instruction to anchor the message, data relating to the anchored message is stored at step 126. In some embodiments, the data may be stored on the smartphone, the server, or both. The data may include but is not limited to the content of the message, the chat room selected, the message sender, the date/time the message was sent, the date/time the message was received, a message identifier (ID) associated with the message, and the like. For example, the user may have selected her friend's name, Bob, from the list of chats on a mobile messaging app to begin conversing with Bob. While conversing with Bob, she may just send a kind message to Bob that she does not want to be buried under later messages or disappear far off the screen over later messages. The user may anchor the kind message to be anchored so that she is reminded of the kind message every time she converses with Bob, or so that she does not have to scroll up to view it each time she wants to find the message. The smartphone and/or the server can store the fact that the message has been anchored by the user. The smartphone and/or the server may store data relating to the anchored message, including the contents of the kind message, the particular chat room between the user and Bob that the user selected, the fact that Bob was the message sender, the fact that the message was sent on Jul. 11, 2024 at 11:15 am, and the like.

As will be illustrated in detail in conjunction with other figures, in some embodiments, a sender can anchor a message that he or she sent. In some embodiments, a sender can anchor a message that he or she received. In some embodiments, a user can anchor a message that he or she sent or received. In some embodiments, a message is anchored (e.g., configured to operate as a future reminder) only for the user anchoring the message. In some embodiments, a message is anchored (e.g., configured to operate as a future reminder) for both the user anchoring the message and the other user with whom the anchoring user is conversing. In some embodiments, a message is anchored (e.g., configured to operate as a future reminder) only for the other user with whom the anchoring user is conversing.

At step 128, the anchored message is then displayed on a portion of the screen. In some embodiments, the portion may be a prominent portion of the screen (e.g., center, top, bottom, etc.) such that the anchored message serves as a clear reminder to the user of the contents of the anchored message. In some embodiments, the anchored message is displayed on the message sender's screen, or the recipient's screen, or both. In some embodiments, the message anchored by the sender, which is displayed on the recipient's screen, may not be allowed to be unanchored by the sender. In some embodiments, the message anchored by the sender, which is displayed on the recipient's screen, may be allowed to be unanchored by the sender. In some embodiments, a message sent as an anchored message is anchored only for the recipient of that anchored message (e.g., the message is not anchored on the sender's screen). In other embodiments, a message sent as an anchored message is anchored for both the recipient and the sender of that anchored message (e.g., the message is anchored on the sender's screen as well as the recipient's screen). In yet other embodiments, a message sent as an anchored message is anchored for only the sender of that anchored message (e.g., the message is not anchored on the recipient's screen). In some embodiments, a message that is anchored by a recipient is anchored only for the recipient of that message (e.g., the message is not anchored on the sender's screen). In other embodiments, a message that is anchored by a recipient is anchored for both the recipient and the sender of that message (e.g., the message is anchored on the sender's screen as well as the recipient's screen). In yet other embodiments, a message that is anchored by a recipient is anchored only for the sender of that message (e.g., the message is not anchored on the recipient's screen).

As will be illustrated in detail in conjunction with other figures, in some embodiments, the display of the anchored message occurs in response to the user opening a specific chat room (e.g., the chat room with the user who sent the anchored message), such that the anchored message is anchored in a contact-specific manner or a chat-room-specific manner, where the trigger is the opening of the chat room where the anchored message was sent or received. In other embodiments, the display of the anchored message occurs in response to the user launching the text messaging app (instead of the user selecting a chat room), such that the anchored message is anchored in an app-wide manner, where the trigger is the opening of the app. In yet other embodiments, the display of the anchored message occurs in response to the user opening a chat room (e.g., any chat room regardless of who sent the anchored message), such that the anchored message is anchored in an app-wide manner, where the trigger is the opening of one of the chat rooms.

In some embodiments, an anchored message displayed on the screen stays in the same screen location as new user inputs are received and/or new messages are sent or received. In other embodiments, an anchored message displayed on the screen is removed as new user inputs are received and/or new messages are sent or received. In yet other embodiments, an anchored message displayed on the screen moves to a different location removed as new user inputs are received and/or new messages are sent or received.

If there are multiple anchored messages, they may be displayed simultaneously or in sequence, such as a chronological sequence (e.g., such that the user can swipe/scroll through them). In some embodiments of the present disclosure, the user may also reorder the multiple anchored messages by another user input, e.g. tapping on one anchored message and select ‘reorder’ from a dropdown menu, performing a long press on the message, swiping in a direction (such as left, right, up, or down) on the message, double tapping on the message, or performing any combination of these.

FIG. 1C depicts a flow diagram of a method 140 for text message anchoring, more specifically for displaying and/or removing the anchored text message in a chat room on a mobile application. The method 140 starts at step 142 when the mobile application detects a second user input that a chat room has been selected from the list of chat rooms on the mobile application. This step may include the application checking whether any message has been anchored by the user in the selected chat room.

At step 144, upon determining that a message was previously anchored by the user, the mobile application can retrieve the stored data associated with the anchored message. The anchored message is then displayed on a portion of the screen at step 146, which is similar to and illustrated in detail in steps 108 and/or 128. For example, the portion may be a prominent portion of the screen (e.g., center, top, bottom, etc.) such that the anchored message serves as a clear reminder to the user of the contents of the anchored message.

Step 144 of retrieving the anchored message occurs each time the user selects the chat room with the anchored message from the list of chat rooms on the mobile application. For example, the user may select a chat between her and her son that has an anchored message from her son about his flight details. Once she selects her son's name from the list of chats on the mobile messaging app on her phone, the mobile application may retrieve the data associated with the fact that the user anchored a message in that chat room. As a result, the anchored message with the details of his flight number may appear on the bottom of the display screen. At a later time, if the user opens the mobile application again and selects the same chat room with her son, the anchored message with the details of his flight number will appear on the bottom of the display screen. The method 140 may include checking whether the user has anchored any message in the chat each time a chat is selected from the list of chat rooms.

At step 148, the mobile application detects a subsequent user input subsequent to or immediately subsequent to the user input of selecting a chat room from the list of chat rooms on the mobile application. In some embodiments, the subsequent input may include interacting with a message in the chat history, selecting the message input field, typing, or interacting with any other part of the display screen. This may include any input that involves tapping, swiping, holding, or other form of contact with the display screen. The user input detected in step 148 causes the anchored message to be removed from the portion of the display screen in step 150. In some embodiments, the anchored message may be reverted to another region of the display based on a chronological or sequential order. One way to implement method 140 is to have any user input in the chat room cause the anchored message to be removed from the region of the display screen. For example, the anchored message will be removed if the user taps on the anchored message, taps on any part of the chat room other than the anchored message, scrolls through the chat history, interacts with another message, selects the message input field, or begins typing. The advantage of being able to detect user input to remove the anchored message is being able to make the reminder fleeting and non-disruptive. This may allow a user to perform a different action in the chat room without valuable screen space being taken up by the anchored message. This may be useful when a user is typing a message, scrolling up to read the chat history, or interacting with a different message.

In some embodiments, at least another portion of a text message between the message sender and the recipient will be displayed or revealed in the region of the display screen where the anchored message was removed. The advantage of this is that the user may view more of the chat history on the display screen. The sender of the portion of the text message may be from any contact in the selected chat in the user's mobile application. In some embodiments, another portion displayed or revealed may include a portion of chat history (in the sequential order) including the anchored message so that the user can review the context. For example, when detecting the user input of tapping on the anchored message at step 148, the mobile application automatically scrolls to the anchored message in the chat history at or after step 150. The anchored message is displayed as part of the chat history (but may include a special indication that it is an anchored message, rather than an unanchored message simply displayed in sequential order).

In other embodiments, the most recent message(s) between the other user with whom the anchoring user is conversing are displayed. The advantage of displaying at least a portion of another text message between the user and the message sender upon detecting user input at step 148 is that it utilizes the newly freed-up space on the displaying screen after the anchored message is removed at step 150. For example, the anchored message may firstly be displayed as if it were the most recent message received from another party in the chat room or sent by the user in the chat room, and disappear (e.g., instantly removed from the screen) as another user input is received and/or as another message is sent or received.

In some embodiments, the user interface allows the anchored messages to be closed individually, one by one (e.g., by touching or swiping the anchored messages on the screen). For example, the user may choose to close anchored messages that are no longer relevant/important, and choose to keep the remaining anchored messages on the screen to serve as a continued reminder. In other embodiments, a user input and/or a new sent or received message may close all of the anchored messages displayed on the screen. Closed messages may be displayed the next time the user opens the mobile application or the chat room.

FIG. 1D depicts a flow diagram of a method 160 for text message anchoring, more specifically for moving the anchored text message to another chat room on a mobile application. In some embodiments, the anchored text message is not displayed in the original chat room upon performing method 160. In some embodiments, the anchored text message may still be displayed in the original chat room upon performing method 160. The method 160 starts at step 161 when the mobile application detects a user input indicating moving the anchored text message to a second chat room. In some embodiments, the user may tap on the message and select ‘move’ from a dropdown menu, perform a long press on the message, swipe in a direction (such as left, right, up, or down) on the message, double tap on the message, or perform any combination of these.

At step 163, upon detecting the user input to move the anchored text message to another chat room, the mobile application can update the stored data associated with the anchored message. In some embodiments, the mobile application can update information about the chat room selected associated with the text message. For example, the information about the chat room selected may be added by or changed to another chat room(s). The chat room(s) may be the same as or different from the original chat room. In some embodiments, the information about the original chat room where the message is originally from may be kept unchanged.

At step 165, as also similar to and illustrated in detail at step 142, when the mobile application detects a user input that a chat room has been selected from the list of chat rooms on the mobile application. In some embodiments, the chat room may be the second chat room. This step may include the application checking whether any message has been anchored by the user in the selected chat room.

At step 167, as also similar to and illustrated in detail at step 144, upon determining that the message was previously anchored, the mobile application can retrieve the updated data associated with the anchored message. Step 167 of retrieving the anchored message occurs each time the user selects any chat room from the list of chat rooms on the mobile application. The method 180 may include checking whether the user has anchored any message in the chat each time a chat is selected from the list of chat rooms.

At step 169, the anchored message is then displayed on a portion of the screen similar to and as illustrated at step 146. For example, the portion may be a prominent portion of the screen (e.g., center, top, bottom, etc.) such that the anchored message serves as a clear reminder to the user of the contents of the anchored message.

FIG. 1E depicts a flow diagram of a method 180 for text message anchoring, more specifically for updating the anchored text message to be anchored in all chat rooms on a mobile application. The method 180 starts at step 181 when the mobile application detects a user input indicating that the anchored text message is to be anchored when any of the list of chat rooms is selected.

At step 183, upon detecting the user input to move the anchored text message to another chat room, the mobile application can update the stored data associated with the anchored message. In some embodiments, the mobile application can update information about the chat room selected associated with the text message. For example, the information about the chat room selected may include all chat rooms on the list, which may include the original chat room. In some embodiments, the information about the original chat room where the message is originally from may be kept unchanged.

At step 185, as also similar to and illustrated in detail at step 142, when the mobile application detects a user input that a chat room has been selected from the list of chat rooms on the mobile application. In some embodiments, the chat room may be any chat room. This step may include the application checking whether any message has been anchored by the user in the selected chat room.

At step 187, as also similar to and illustrated in detail at step 144, upon determining that the message was previously anchored, the mobile application can retrieve the updated data associated with the anchored message. Step 187 of retrieving the anchored message occurs each time the user selects any chat room from the list of chat rooms on the mobile application. The method 180 may include checking whether the user has anchored any message in the chat each time a chat is selected from the list of chat rooms.

At step 189, the anchored message is then displayed on a portion of the screen similar to and as illustrated at step 146. For example, the portion may be a prominent portion of the screen (e.g., center, top, bottom, etc.) such that the anchored message serves as a clear reminder to the user of the contents of the anchored message.

FIG. 1F depicts a flow diagram of a method 190 for text message anchoring, more specifically for unanchoring/releasing the anchored text message from being anchored on a mobile application. The method 190 starts at step 192 when the mobile application detects a user input indicating that the anchored text message is to be unanchored. In some embodiments, the user input may include tapping on the text message and selecting ‘unanchor’ from a dropdown menu, performing a long press on the text message, swiping in a direction (such as left, right, up, or down) on the text message, and double tapping on the text message. This may include any input that involves tapping, swiping, holding, or other form of contact with the display screen. The user input detected in step 192 causes the anchored message to be removed from the portion of the display screen in step 196. At step 194, upon detecting the user input to unanchor the anchored text message, the mobile application can delete the stored data associated with the anchored message. At step 196, the mobile application may cause the anchored message to be removed from the portion of the display screen and reveal the portion of the display screen.

In some embodiments, the mobile application/user interface allows the anchored messages to be unanchored individually, one by one. For example, the user may choose to unanchor certain anchored messages that are no longer relevant/important, and choose to keep the remaining anchored messages anchored such that they can be displayed again at the next trigger (e.g., opening of the app, opening of a specific chat room, or opening of any chat room, as described herein). In other embodiments, a specific user input (e.g., activation of an “unanchor all” button on the screen) may unanchor all of the anchored messages displayed on the screen.

Not shown in the above figures, in some embodiments, the mobile application detects a user input indicating duplicating the anchored text message like step 104. The user may tap on the message and select ‘manage’ or ‘duplicate’ from a dropdown menu, perform a long press on the message, swipe in a direction (such as left, right, up, or down) on the message, double tap on the message, or perform any combination of these. Upon detecting the user input to duplicate the anchored text message, the mobile application may update the stored data associated with the anchored message as illustrated in step 106.

The anchored message may be duplicated within a chat room or to another chat room of a list of chat rooms on the mobile application. The anchored message may also be duplicated to contacts of phone calls or video calls within or outside the mobile application. The mobile application or other applications may cause the anchored message to be displayed as illustrated in step 108.

In some embodiments, the anchored message may be duplicated outside of the mobile application, e.g. phone call application, camera, navigation, etc. For example, John may send a message to the user that he prefers texting after 9 pm since his baby would be woken up from phone calling. The user may anchor this text message and duplicate it to phone call application. When the user calls John, the anchored message will appear to remind the user that John prefers texting after 9 pm. As another example, the user may anchor a text message that the son needs a headshot picture. When the user opens the camera, this message will appear to remind the user that the son needs a headshot. As yet another example, the user may anchor a text message from Susan about not parking beside her house since it's a very active tow-away zone. When the user opens the navigation application to direct the user to Susan's house, this message will appear to remind the user not to park beside Susan's house.

In some embodiments, the anchored messages in other applications will continue to appear unless it is closed as illustrated above. In some embodiment, the anchored messages in other applications will reappear each time the user restarts the specified app unless the anchored message is unanchored within the specific application in the same way it is done in the messaging application as illustrated above.

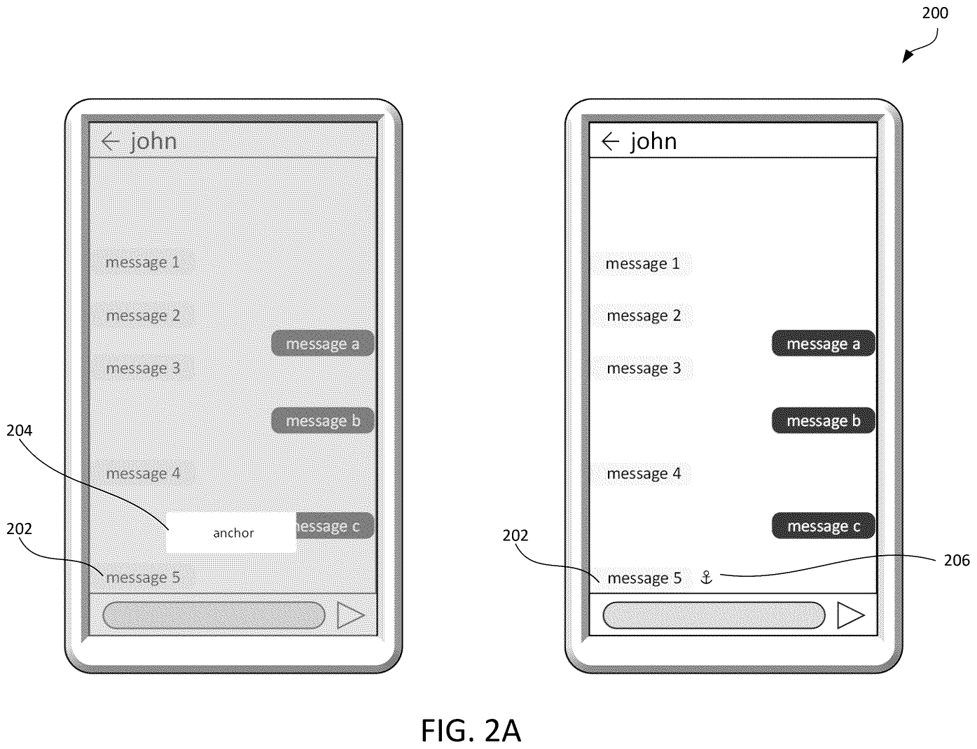

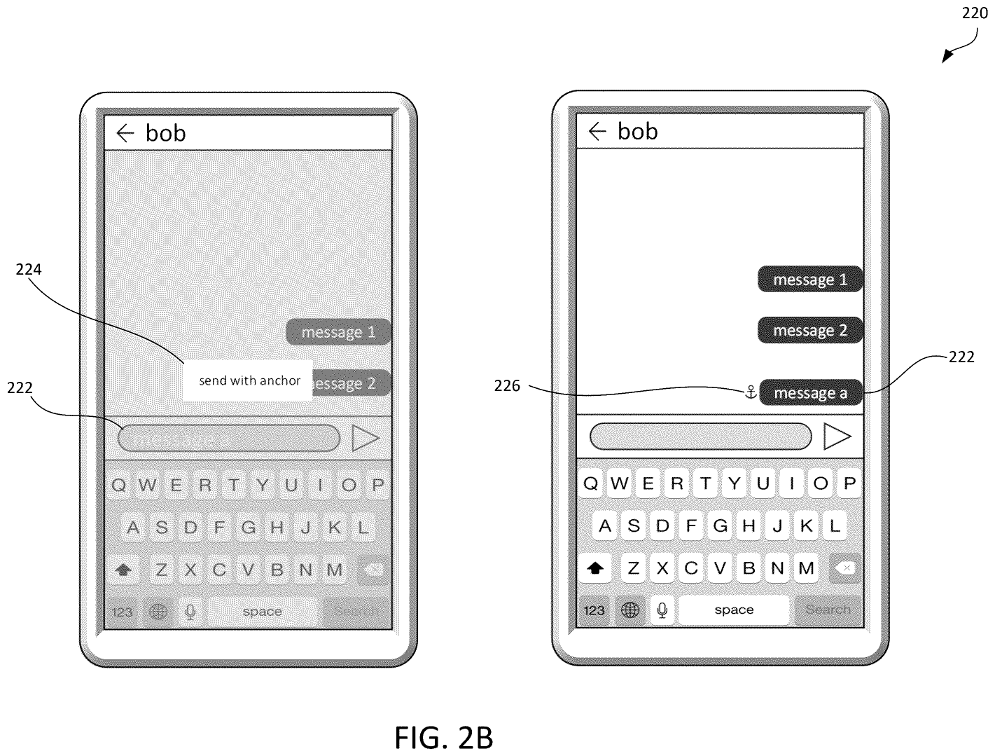

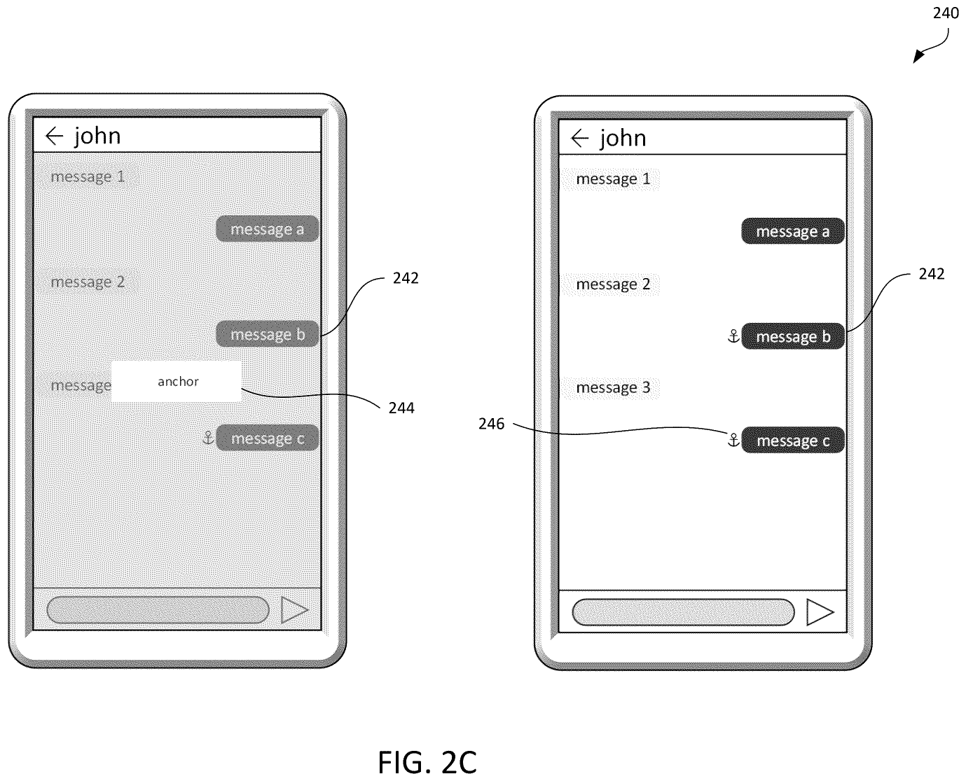

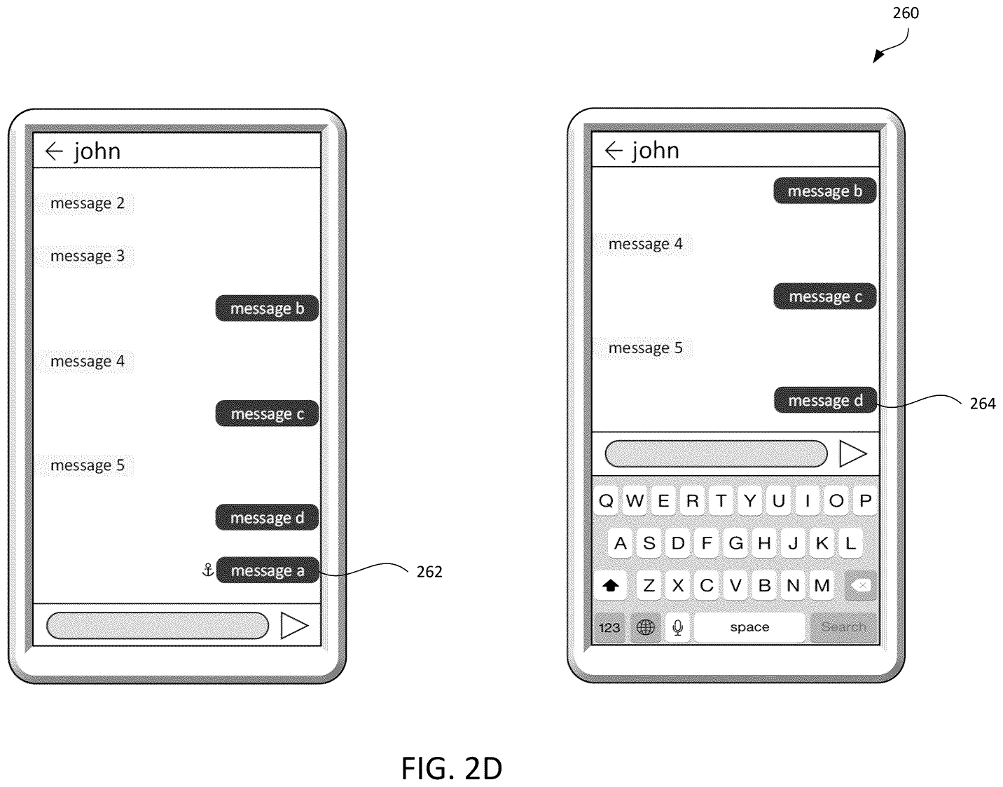

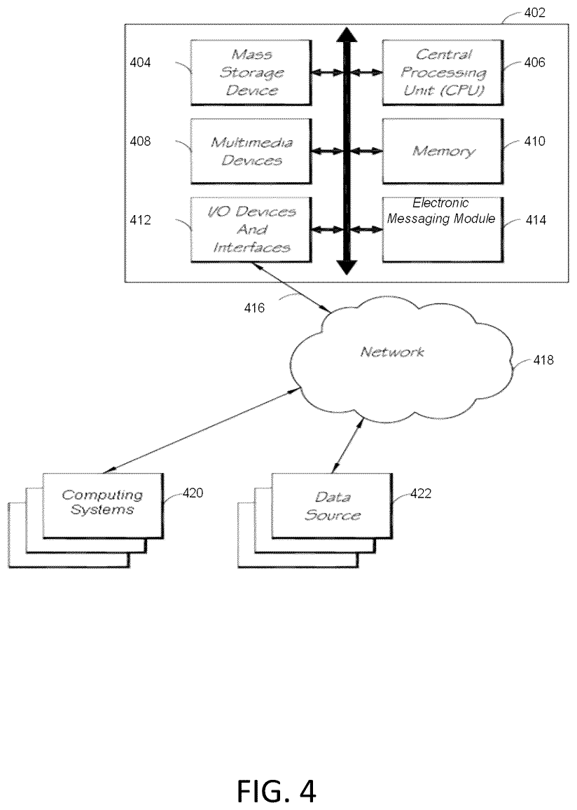

FIG. 2A illustrates a diagram depicting a system implementing embodiments of methods for text message anchoring of the present disclosure. In some embodiments, the system 200 may include one or more devices running a mobile application configured for people chatting with others. As illustrated in detail in conjunction with FIG. 4, the device can be any computing device such as a desktop, a laptop, a mobile phone (or smartphone), or a tablet. The system 200 depicts some embodiments of the method for text message anchoring as illustrated in conjunction with FIG. 1A. For example, the message 202 can be a message that is received by a user (e.g. a message recipient) from a message sender in a chat room on a mobile application on the user's smartphone. In some embodiments, the message 202 can be the most recent message received by the user.

When the user wants to anchor the message 202, the user may indicate it by a user input to cause the mobile application to anchor the message 202. In some embodiments, the user may perform a long press on the message 202 and the mobile application may pop up a menu 204 including an ‘anchor’ option as shown in FIG. 2A. The user may select ‘anchor’ from the menu 204 to anchor the message. In some embodiments, the user may perform a short press on the message, a normal press on the message, swipe in a direction (such as left, right, up, or down) on the message, double tap on the message, or perform any combination of these to anchor the message 202. In some embodiments, the user may perform any of these or any combination of these to cause the mobile application to pop up the menu 204 and the user may select ‘anchor’ from the menu 204 to anchor the message.

Upon the mobile application detects the user input indicating that a message 202 is to be anchored, data relating to the message 202 is stored. For example, the data may be stored on the device, the server, or both. The data may include but is not limited to the content of the message, the chat room selected, the message sender, the date/time the message was sent, the date/time the message was received, a message identifier (ID) associated with the message, and the like.

The anchored message 202 is then displayed on a portion of the screen as shown. In some embodiments, the portion may be a prominent portion of the screen (e.g., center, top, bottom, etc.) such that the anchored message serves as a clear reminder to the user of the contents of the anchored message. In some embodiments, an anchor mark 206 as shown in FIG. 2A may be displayed around the message 202. The anchor mark 206 can be at any close location around the message 202 without further limitations.

FIG. 2B illustrates a diagram depicting a system implementing embodiments of methods for text message anchoring of the present disclosure. In some embodiments, the system 220 may include one or more devices running a mobile application configured for people chatting with others. As illustrated in detail in conjunction with FIG. 4, the device can be any computing device such as a desktop, a laptop, a mobile phone (or smartphone), or a tablet. The system 220 depicts some embodiments of the method for text message anchoring as illustrated in conjunction with FIG. 1B. For example, the message 222 can be a message that is being sent by a user (e.g. a message sender) to a message receiver in a chat room on a mobile application on the user's smartphone.

When the user wants to anchor the message 222 before sending, the user may indicate it by a user input to cause the mobile application to anchor the message 222. In some embodiments, when the user preforms a long press on ‘send’ button, the mobile application may pop up an ‘anchor’ menu 224 and the user may select ‘anchor’ from the menu before the message is sent out. In some embodiments, when the user long-presses the ‘send’ button, the mobile application may cause the send button to depict an ‘anchor’ and the user may tap the ‘anchor.’ In some embodiments, the user may perform a press, either short, normal, or long, on the input field or the message to be sent, swipe in a direction (such as left, right, up, or down) on the input field or the message to be sent, double tap on the input field or the message to be sent, or perform any combination of these. In some embodiments, the user may perform any of these or any combination of these to cause the mobile application to pop up an ‘anchor’ menu. The user may select ‘anchor’ from the menu.

Upon receiving the user's instruction to anchor the message, data relating to the anchored message is stored. In some embodiments, the data may be stored on the smartphone, the server, or both. The data may include but is not limited to the content of the message, the chat room selected, the message sender, the date/time the message was sent, the date/time the message was received, a message identifier (ID) associated with the message, and the like.

The anchored message 222 is then displayed on a portion of the screen. In some embodiments, the portion may be a prominent portion of the screen (e.g., center, top, bottom, etc.) such that the anchored message serves as a clear reminder to the user of the contents of the anchored message. In some embodiments, an anchor mark 226 as shown in FIG. 2A may be displayed around the message 222. The anchor mark 226 can be at any close location around the message 222 without further limitations. In some embodiments, the anchored message 222 is displayed on the message sender's screen as shown in FIG. 2B, or the recipient's screen, or both. In some embodiments, the message anchored by the sender, which is displayed on the recipient's screen, may not be allowed to unanchor the message by the sender.

FIG. 2C illustrates a diagram depicting a system implementing embodiments of methods for text message anchoring of the present disclosure. In some embodiments, the system 240 may include one or more devices running a mobile application configured for people chatting with others. As illustrated in detail in conjunction with FIG. 4, the device can be any computing device such as a desktop, a laptop, a mobile phone (or smartphone), or a tablet. The system 240 depicts some embodiments of the method for text message anchoring. The message 242 can be any message that is received or sent by a user (e.g. a message sender or a message recipient). In some embodiments, the user may perform a long press on the message 242 and the mobile application may pop up a menu 244 including an ‘anchor’ option as shown in FIG. 2C. The user may select ‘anchor’ from the menu 224 to anchor the message. In some embodiments, the user may perform a short press on the message, a normal press on the message, swipe in a direction (such as left, right, up, or down) on the message, double tap on the message, or perform any combination of these to anchor the message 242. In some embodiments, the user may perform any of these or any combination of these to cause the mobile application to pop up the menu 244 and the user may select ‘anchor’ from the menu 244 to anchor the message.

Upon the mobile application detects the user input indicating that a message 242 is to be anchored, data relating to the message 242 is stored. For example, the data may be stored on the device, the server, or both. The data may include but is not limited to the content of the message, the chat room selected, the message sender, the date/time the message was sent, the date/time the message was received, a message identifier (ID) associated with the message, and the like. The anchored message 242 is then displayed on a portion of the screen as shown. In some embodiments, the portion may be a prominent portion of the screen (e.g., center, top, bottom, etc.) such that the anchored message serves as a clear reminder to the user of the contents of the anchored message. In some embodiment, an anchor mark 246 as shown in FIG. 2C may be displayed around the anchored message 242. The anchor mark 246 can be at any close location around the anchored message 242 without further limitations.

FIG. 2D illustrates a diagram depicting a system implementing embodiments of methods for text message anchoring of the present disclosure. In some embodiments, the system 260 may include one or more devices running a mobile application configured for people chatting with others. As illustrated in detail in conjunction with FIG. 4, the device can be any computing device such as a desktop, a laptop, a mobile phone (or smartphone), or a tablet. The system 260 depicts some embodiments of the method for text message anchoring as illustrated in conjunction with FIG. 1C.

The mobile application may detect a user input that a chat room has been selected from the list of chat rooms on the mobile application. The mobile application may further check whether any message has been anchored by the user in the selected chat room. Upon determining that a message 262 was anchored, the mobile application can retrieve the data associated with the anchored message 262. The anchored message 262 is then displayed on a portion of the screen. The mobile application may detect a subsequent user input subsequent to or immediately subsequent to the user input of selecting a chat room on the mobile application. In some embodiments, the subsequent input may include interacting with a message in the chat history, selecting the message input field, typing, or interacting with any other part of the display screen. This may include any input that involves tapping, swiping, holding, or other form of contact with the display screen.

The detected subsequent user input may cause the anchored message 262 to be removed from the portion of the display screen as shown. In some embodiments, the anchored message 262 may be reverted to another region of the display based on a chronological or sequential order. In some embodiments, at least another portion of a text message between the message sender and the recipient will be displayed or revealed in the region of the display screen where the anchored message was removed. In some embodiments, another portion displayed or revealed may include a portion of chat history (in the sequential order) including the anchored message so that the user can review the context in which the message was received. For example, the mobile application automatically scrolls to the anchored message in the chat history. The anchored message is displayed as part of the chat history (but may include a special indication that it is an anchored message, rather than an unanchored message simply displayed in sequential order). For another example as shown in FIG. 2D, the anchored message 262 has been displayed as if it were the most recent message received from another party in the chat room or sent by the user in the chat room, and disappear (e.g., moved up or down) along with the rest of the chat history as additional messages are received and/or sent. The most recent message(s) 264 are then displayed.

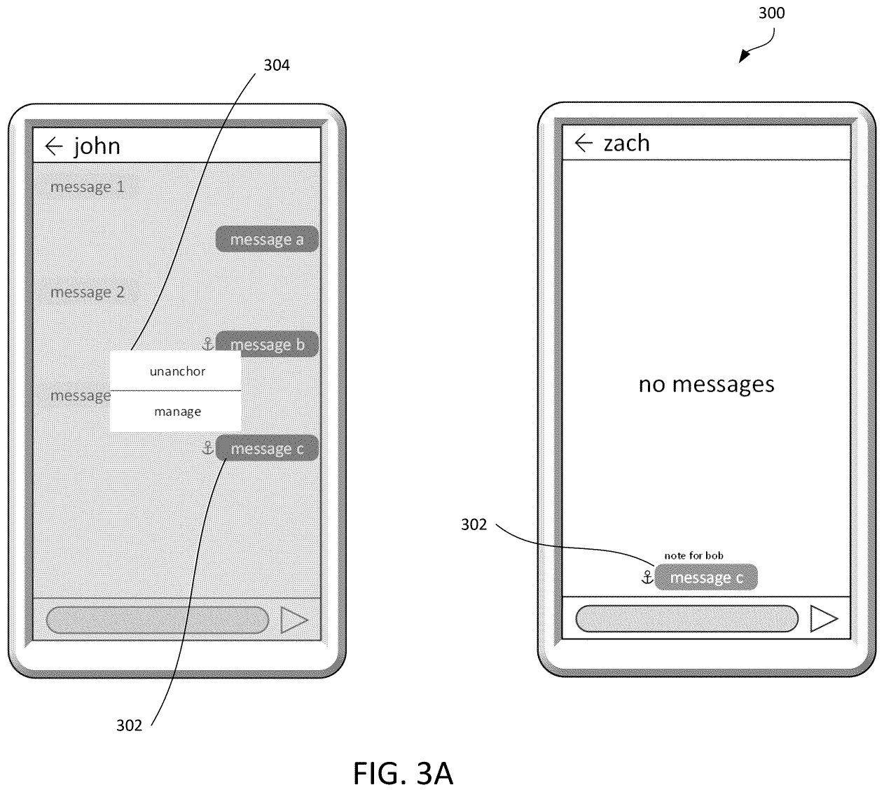

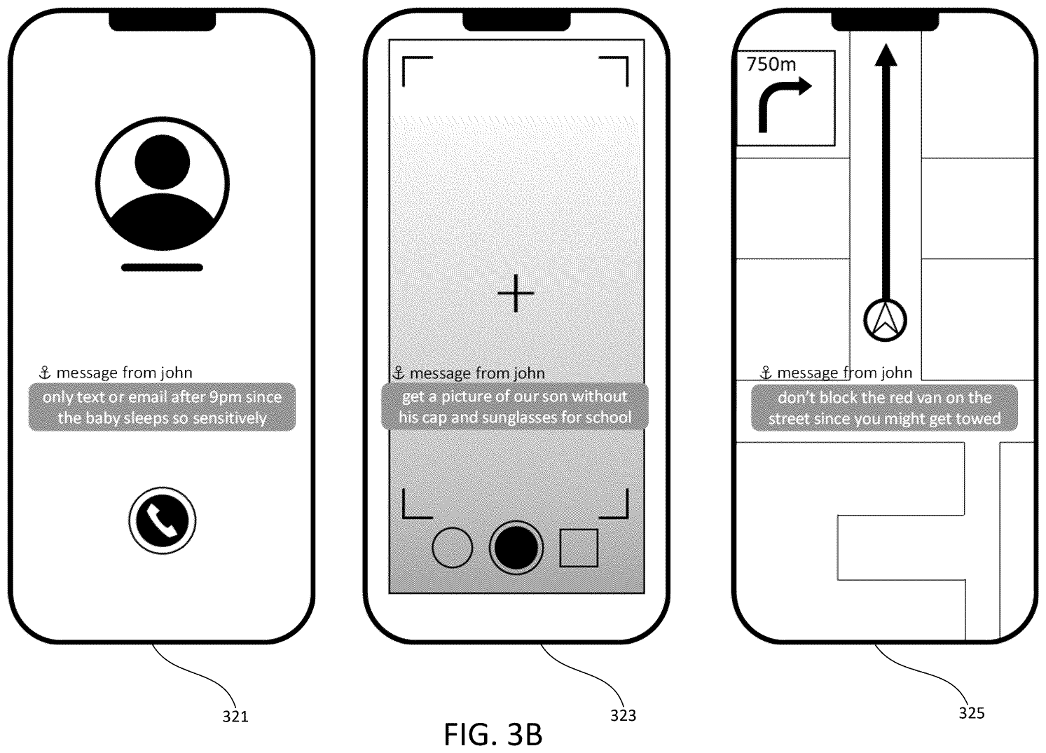

FIG. 3A illustrates a diagram depicting a system implementing embodiments of methods for text message anchoring of the present disclosure. In some embodiments, the system 300 may include one or more devices running a mobile application configured for people chatting with others. As illustrated in detail in conjunction with FIG. 4, the device can be any computing device such as a desktop, a laptop, a mobile phone (or smartphone), or a tablet. The system 300 depicts some embodiments of the methods for anchoring a text message as illustrated in conjunction with FIGS. 1D-IF.

When the user wants to update/manage the anchored message 302, the user may indicate it by a user input to cause the mobile application to update/manage the anchored message 302. In some embodiments, to indicate the user's wish, the user may perform a long press on the anchored message 302, the mobile application may pop up a menu 304. In some embodiments, the user may perform a press, either short, normal, or long, the message to be sent, swipe in a direction (such as left, right, up, or down) on the input field or the message to be sent, double tap on the input field or the message to be sent, or perform any combination of these. In some embodiments, the user may perform any of these or any combination of these to cause the mobile application to pop up the ‘anchor’ menu 304. In some embodiments, the menu 304 can include an option to move the anchored message as illustrated in conjunction with FIG. 1D, an option to anchor app-wide as illustrated in conjunction with FIG. 1E, an option to unanchor the message as illustrated in conjunction with FIG. 1F, or an option to duplicate the anchored message as will be illustrated above.

In some embodiments, upon detecting the user input to update/manage the anchored text message 302, the mobile application can update the stored data associated with the anchored message. In some embodiments, the mobile application can update information about the chat room(s) selected associated with the text message. For example, the information about the chat room to be selected may be added by or changed to another chat room(s). The chat room(s) can be the same as or different from the original chat room. In some embodiments, the information about the original chat room where the message is originally from may be kept unchanged. In some embodiments, upon detecting the user input to unanchor the anchored text message, the mobile application can delete the stored data associated with the anchored message. The mobile application may cause the anchored message to be removed from the portion of the display screen and reveal the portion of the display screen.

The mobile application may detect a user input that a chat room has been selected from the list of chat rooms on the mobile application. The mobile application may further check whether any message has been anchored by the user in the selected chat room.

Upon determining that a message 302 is anchored in the selected chat room, the mobile application can retrieve the data associated with the anchored message. The anchored message 302 is then displayed on a portion of the screen. For example, the anchored message 302 was a message sent from Bob to John. Upon updating the anchored message 302 to be anchored in the chat room with Zach, the anchored message 302 is displayed on a portion of the screen. The portion may be a prominent portion of the screen (e.g., center, top, bottom, etc.) such that the anchored message serves as a clear reminder to the user of the contents of the anchored message. In some embodiment, an anchor mark as shown in FIG. 3A may be displayed around the anchored message 302. The anchor mark can be at any close location around the message 302 without further limitations. Other information related to the anchored message 302, such as the chat room originally selected, may also be displayed around the anchored message 302.

FIG. 3B illustrates diagrams depicting another system implementing embodiments of methods for text message anchoring of the present disclosure. In some embodiments, the system may include one or more devices running a mobile application configured for people chatting with others. As illustrated in detail in conjunction with FIG. 4, the device can be any computing device such as a desktop, a laptop, a mobile phone (or smartphone), or a tablet. The system 300 depicts some embodiments of the methods for anchoring a text message as illustrated above to anchor message out of the mobile application for people chatting with others.

As detailly illustrated above, in some embodiments, the anchored message may be duplicated outside of the mobile application, e.g. phone call application, camera, navigation, etc. In one embodiment, the system 321 may cause the anchored message to appear on a phone call application to remind the user that John prefers texting after 9 pm, if the user manages the corresponding anchored message to be anchored at the phone call application. In another embodiment, the system 323 may cause the anchored message to appear on a camera application to remind the user that the son needs a headshot picture when the user opens the camera application if the user manages the corresponding anchored message to be anchored at the camera application. In yet another embodiment, the system 325 may cause the anchored message to appear on a navigation application to remind the user not block the red van on the street if the user manages the corresponding anchored message to be anchored at the navigation application.

In some embodiments, the anchored messages in other applications will continue to appear unless it is closed as illustrated above. In some embodiment, the anchored messages in other applications will reappear each time the user restarts the specified app unless the anchored message is unanchored within the specific application in the same way it is done in the messaging application as illustrated above.

As noted above, the anchoring and/or the displaying of anchored messages can be phone-specific, the recipient-user-specific, and/or sender-user-specific. For example, the anchored message(s) can be displayed (1) the next time the recipient opens the chat app, or (2) the next time the recipient opens the chat room with the person who sent the anchored message.

In some embodiments, how the message is anchored or the weight of the anchoring may be based on the contact with whom the anchoring user is conversing, or the frequency at which the anchoring user converses with the contact. For example, if the contact is one of the anchoring user's favorites, then messages from the contact may be anchored in a contact specific manner (anchored message displayed whenever the chat room with the contact is opened), and if not, the messages from the contact may be anchored in an app specific (anchored message displayed whenever the app is opened) or device specific manner (anchored message displayed whenever the device is turned on). In other embodiments, the opposite occurs (e.g., if the contact is one of the anchoring user's favorites, the message is anchored in an app specific or device specific manner, and if not, the message is anchored in a contact specific manner).

As another example, if the anchoring user chats with the contact more frequently than a threshold frequency (e.g., every day), then messages from the contact may be anchored in a contact specific manner (anchored message displayed whenever the chat room with the contact is opened), and if not, the messages from the contact may be anchored in an app specific (anchored message displayed whenever the app is opened) or device specific manner (anchored message displayed whenever the device is turned on). In other embodiments, the opposite occurs (e.g., if the anchoring user chats with the contact more frequently than a threshold frequency, the message is anchored in an app specific or device specific manner, and if not, the message is anchored in a contact specific manner).

### Computer System

In some embodiments, the systems, processes, and methods described herein are implemented using a computing system, such as the one illustrated in FIG. 4. The example computer system 402 is in communication with one or more computing systems 420 and/or one or more data sources 422 via one or more networks 418. The computer system 402 can be any computing device such as a desktop, a laptop, a mobile phone (or smartphone), a tablet, a kiosk, a television, a wristwatch (including a smartwatch), a wireless device, a media player, one or more processor devices, integrated circuit components for inclusion in computing devices, and the like. Additionally, the one or more networks 418 may be any wired network, wireless network, or combination thereof. In addition, the one or more networks 418 may be a personal area network, local area network, wide area network, over-the-air broadcast network, cable network, satellite network, cellular telephone network, or combinations thereof. In some embodiments, the one or more networks 418 may be a private or semi-private network, and may include one or more wireless networks, such as a Global System for Mobile Communications (GSM) network, a Code Division Multiple Access (CDMA) network, a Long Term Evolution (LTE) network, or any other type of wireless network. The one or more networks 418 can use protocols and components for communicating via the Internet or any of the other aforementioned types of networks.

While FIG. 4 illustrates an embodiment of a computing system 402, it is recognized that the functionality provided for in the components and modules of computer system 402 can be combined into fewer components and modules, or further separated into additional components and modules.

The computer system 402 can comprise an electronic messaging module 414 that carries out the functions, methods, acts, and/or processes described herein. The electronic messaging module 414 is executed on the computer system 402 by a central processing unit 406 discussed further below.

In general the word “module,” as used herein, refers to logic embodied in hardware or firmware or to a collection of software instructions, having entry and exit points. Modules are written in a program language, such as JAVA, C, or C++, or the like. Software modules can be compiled or linked into an executable program, installed in a dynamic link library, or can be written in an interpreted language such as BASIC, PERL, LAU, PHP or Python and any such languages. Software modules can be called from other modules or from themselves, and/or can be invoked in response to detected events or interruptions. Modules implemented in hardware include connected logic units such as gates and flip-flops, and/or can include programmable units, such as programmable gate arrays or processors.

Generally, the modules described herein refer to logical modules that can be combined with other modules or divided into sub-modules despite their physical organization or storage. The modules are executed by one or more computing systems, and can be stored on or within any suitable computer readable medium, or implemented in-whole or in-part within special designed hardware or firmware. Not all calculations, analysis, and/or optimization require the use of computer systems, though any of the above-described methods, calculations, processes, or analyses can be facilitated through the use of computers. Further, in some embodiments, process blocks described herein can be altered, rearranged, combined, and/or omitted.

### Computing System Components

The computer system 402 includes one or more processing units (CPU) 406, which can comprise a microprocessor. The computer system 402 further includes a physical memory 44, such as random access memory (RAM) for temporary storage of information, a read only memory (ROM) for permanent storage of information, and a mass storage device 404, such as a backing store, hard drive, rotating magnetic disks, solid state disks (SSD), flash memory, phase-change memory (PCM), 3D XPoint memory, diskette, or optical media storage device. Alternatively, the mass storage device can be implemented in an array of servers. Typically, the components of the computer system 402 are connected to the computer using a standards based bus system. The bus system can be implemented using various protocols, such as Peripheral Component Interconnect (PCI), Micro Channel, SCSI, Industrial Standard Architecture (ISA) and Extended ISA (EISA) architectures.

The computer system 402 includes one or more input/output (I/O) devices and interfaces 412, such as a keyboard, mouse, touch pad, and printer. The I/O devices and interfaces 412 can include one or more display devices, such as a monitor, that allows the visual presentation of data to a user. More particularly, a display device provides for the presentation of GUIs as application software data, and multi-media presentations, for example. The I/O devices and interfaces 412 can also provide a communications interface to various external devices. The computer system 402 can comprise one or more multi-media devices 408, such as speakers, video cards, graphics accelerators, and microphones, for example.

### Computing System Device/Operating System

The computer system 402 can run on a variety of computing devices, such as a server, a Windows server, a Structure Query Language server, a Unix Server, a personal computer, a laptop computer, and so forth. In other embodiments, the computer system 402 can run on a cluster computer system, a mainframe computer system and/or other computing system suitable for controlling and/or communicating with large databases, performing high volume transaction processing, and generating reports from large databases. The computing system 402 is generally controlled and coordinated by an operating system software, such as z/OS, Windows, Linux, UNIX, BSD, PHP, SunOS, Solaris, MacOS, ICloud services or other compatible operating systems, including proprietary operating systems. Operating systems control and schedule computer processes for execution, perform memory management, provide file system, networking, and I/O services, and provide a user interface, such as a graphical user interface (GUI), among other things.

### Network

The computer system 402 illustrated in FIG. 4 is coupled to a network 418, such as a LAN, WAN, or the Internet via a communication link 416 (wired, wireless, or a combination thereof). Network 418 communicates with various computing devices and/or other electronic devices. Network 418 is communicating with one or more computing systems 420 and one or more data sources 222. The electronic messaging module 414 can access or can be accessed by computing systems 420 and/or data sources 422 through a web-enabled user access point. Connections can be a direct physical connection, a virtual connection, and other connection type. The web-enabled user access point can comprise a browser module that uses text, graphics, audio, video, and other media to present data and to allow interaction with data via the network 418.

The output module can be implemented as a combination of an all-points addressable display such as a cathode ray tube (CRT), a liquid crystal display (LCD), a plasma display, or other types and/or combinations of displays. The output module can be implemented to communicate with input devices 412 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module can communicate with a set of input and output devices to receive signals from the user.

### Other Systems

The computing system 402 can include one or more internal and/or external data sources (for example, data sources 422). In some embodiments, one or more of the data repositories and the data sources described above can be implemented using a relational database, such as DB2, Sybase, Oracle, CodeBase, and Microsoft® SQL Server as well as other types of databases such as a flat-file database, an entity relationship database, and object-oriented database, and/or a record-based database.

The computer system 402 can also access one or more databases 422. The databases 422 can be stored in a database or data repository. The computer system 402 can access the one or more databases 422 through a network 418 or can directly access the database or data repository through I/O devices and interfaces 412. The data repository storing the one or more databases 422 can reside within the computer system 402.

### URLs and Cookies

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Doman Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

### Additional Example Embodiments

A method, comprising:
a) receiving a text message from a message sender in a chat room between the message sender and a message recipient on a mobile application executing on a smartphone associated with the message recipient;
b) detecting a first user input from the message recipient with respect to the text message indicating that the text message is to be anchored;
c) anchoring the text message such that the text message is displayed on a display screen of the smartphone in response to the message recipient selecting the chat room between the message sender and the message recipient from a list of chat rooms on the mobile application;
d) in response to detecting a second user input from the message recipient selecting the chat room with the message sender and the message recipient from the list of chat rooms on the mobile application, causing the text message to be displayed on a region of the display screen; and
e) in response to detecting a user input from the message recipient immediately subsequent to the second user input, causing (i) the text message to be removed from the region of the display screen and (ii) at least a portion of another text message between the message sender and the message recipient to be displayed in the region of the display screen from the text message was removed.

### Other Embodiments

While operations may be depicted in the drawings or described in the specification in a particular order, such operations need not be performed in the particular order shown or in sequential order, or that all operations be performed, to achieve desirable results. In particular, elements presented relating to GUI elements or displays to a user may be presented in any particular order to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some examples, the actual steps taken in the processes illustrated and/or disclosed may differ from those shown in the figures. Depending on the example, certain of the steps described above may be removed or others may be added. Furthermore, the features and attributes of the specific examples disclosed above may be combined in different ways to form additional examples, all of which fall within the scope of the present disclosure. Also, the separation of various system components in the implementations described above should not be understood as requiring such separation in all implementations, and it should be understood that the described components and systems can generally be integrated together in a single product or packaged into multiple products. For example, any of the features described herein can be provided separately, or integrated together (e.g., packaged together, or attached together).

For purposes of this disclosure, certain aspects, advantages, and novel features are described herein. Not necessarily all such advantages may be achieved in accordance with any particular example. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain examples include, while other examples do not include, certain features, elements, and/or steps. Thus, such conditional language is not generally intended to imply that features, elements, and/or steps are in any way required for one or more examples or that one or more examples necessarily include logic for deciding, with or without user input or prompting, whether these features, elements, and/or steps are included or are to be performed in any particular example.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain examples require the presence of at least one of X, at least one of Y, and at least one of Z.

Language of degree used herein, such as the terms “approximately,” “about,” “generally,” and “substantially” represent a value, amount, or characteristic close to the stated value, amount, or characteristic that still performs a desired function or achieves a desired result.

The scope of the present disclosure is not intended to be limited by the specific disclosures of preferred examples in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Although the foregoing invention has been described in terms of certain preferred embodiments, other embodiments will be apparent to those of ordinary skill in the art. Additionally, other combinations, omissions, substitutions and modification will be apparent to the skilled artisan, in view of the disclosure herein. Accordingly, the present invention is not intended to be limited by the recitation of the preferred embodiments, but is instead to be defined by reference to the appended claims. All references cited herein are incorporated by reference in their entirety.

The terminology used in the description presented herein is not intended to be interpreted in any limited or restrictive manner and unless otherwise indicated refers to the ordinary meaning as would be understood by one of ordinary skill in the art in view of the specification. Furthermore, embodiments may comprise, consist of, consist essentially of, several novel features, no single one of which is solely responsible for its desirable attributes or is believed to be essential to practicing the embodiments herein described. As used herein, the section headings are for organizational purposes only and are not to be construed as limiting the described subject matter in any way. All literature and similar materials cited in this application, including but not limited to, patents, patent applications, articles, books, treatises, and internet web pages are expressly incorporated by reference in their entirety for any purpose. When definitions of terms in incorporated references appear to differ from the definitions provided in the present teachings, the definition provided in the present teachings shall control. It will be appreciated that there is an implied “about” prior to the temperatures, concentrations, times, etc. discussed in the present teachings, such that slight and insubstantial deviations are within the scope of the present teachings herein.

Although this disclosure is in the context of certain embodiments and examples, those of ordinary skill in the art will understand that the present disclosure extends beyond the specifically disclosed embodiments to other alternative embodiments and/or uses of the embodiments and obvious modifications and equivalents thereof. In addition, while several variations of the embodiments have been shown and described in detail, other modifications, which are within the scope of this disclosure, will be readily apparent to those of ordinary skill in the art based upon this disclosure. It is also contemplated that various combinations or sub-combinations of the specific features and aspects of the embodiments may be made and still fall within the scope of the disclosure. It should be understood that various features and aspects of the disclosed embodiments can be combined with, or substituted for, one another in order to form varying modes or embodiments of the disclosure. Thus, it is intended that the scope of the present disclosure herein disclosed should not be limited by the particular disclosed embodiments described above.

### Additional Embodiments

In some embodiments, the techniques described herein can be extended to other messaging contexts like email. For example, a received email may be “anchored” so that it floats to the top of the inbox (e.g., where the newest email appears).

In some embodiments, one or more contacts or email senders can be designated by the recipient to be able to send anchored messages or emails, which would be anchored to the bottom (if that is where the latest messages appear) or float to the top (if that is where the latest messages appear), until unanchored by the recipient. Anchored messages or emails from an undesignated or unauthorized sender may be received like any other unanchored message or email. Designation or authorization to anchor messages may expire after one time, a specific number of messages or emails, or may not expire until undesignated by the recipient.

In some embodiments, the anchored email or message is displayed out of turn or out of sequence for a specific number of times (e.g., displayed 5 times), until a specific date (e.g., until September 5), or for a specific duration (e.g., for the next 2 weeks), and become automatically unanchored. In some embodiments, anchored messages or emails continue to be displayed out of turn or out of sequence indefinitely until manually unanchored. Such parameters can be configured by the sender, the recipient, or both.

What is claimed is:

1. A method for anchoring a received message, comprising:
receiving a first text message from a message sender in a chat room between the message sender and a message recipient on a mobile application executing on a smartphone associated with the message recipient;
detecting a first anchoring user input from the message recipient with respect to the first text message indicating that the first text message is to be anchored;
anchoring the first text message such that the first text message is displayed on a display screen of the smartphone in response to the message recipient selecting the chat room between the message sender and the message recipient from a list of chat rooms on the mobile application;
in response to detecting a first selecting user input from the message recipient selecting the chat room with the message sender and the message recipient from the list of chat rooms on the mobile application, causing the first text message to be displayed on a region of the display screen; and
in response to detecting a subsequent user input from the message recipient subsequent to the first selecting user input, causing (i) the first text message to be removed from the region of the display screen and (ii) at least a portion of another text message between the message sender and the message recipient to be displayed in the region of the display screen from the first text message was removed.

2. The method according to claim 1, wherein the first anchoring user input indicating that the text message is to be anchored comprises tapping on the text message and selecting ‘anchor’ from a dropdown menu, performing a long press on the text message, swiping in a direction on the text message, and double tapping on the text message.

3. The method according to claim 1, wherein the subsequent user input from the message recipient subsequent to the first selecting user input comprises scrolling up and/or down, tapping on an input field, and typing.

4. The method according to claim 1 further comprises, storing anchoring data associated with the first text message.

5. The method according to claim 4, wherein causing the text message to be displayed on the region of the display screen further comprises:
retrieving the anchoring data associated with the first text message, and
displaying the text message on the region of the display screen of the display screen.

6. The method according to claim 1 further comprises:
detecting a second anchoring user input from the message recipient with respect to a second text message indicating that the second text message is to be anchored, wherein the second text message is either received from the message recipient or sent by the message recipient, and
anchoring the second text message such that the second text message is displayed on the display screen of the smartphone,
wherein anchoring the second text message comprising, when the chat room between the message sender and the message recipient is open on the mobile application, causing the second text message to be displayed on a second region of the display screen.

7. The method according to claim 1, further comprises:
detecting an application-wide anchoring user input from the message recipient with respect to the first text message indicating that the first text message is to be anchored when any of the list of chat rooms on the mobile application is selected, and
in response to detecting an application-wide selecting user input from the message recipient selecting any chat room from the list of chat rooms on the mobile application, causing the text message to be displayed on the region of the display screen.

8. The method according to claim 1, further comprises:
detecting a moving user input from the message recipient indicating that the first text message is to be moved to a second chat room and be anchored in the second chat room, wherein the second chat room comprises any chat room between the message recipient and others not including the message sender, and
in response to detecting a second selecting user input from the message recipient selecting the second chat room from the list of chat rooms on the mobile application, causing the text message to be displayed on the region of the display screen.

9. The method according to claim 8, further comprises removing the text message from the region of the display screen when the chat room between the message sender and the message recipient is selected.

10. The method according to claim 1, further comprising:
detecting a removing user input from the message recipient indicating that the first text message is to be removed from being anchored, and
in response to the removing user input, causing (i) the first text message to be removed from the region of the display screen, (ii) at least the portion of another text message between the message sender and the message recipient to be displayed in the region of the display screen from the first text message was removed, and (iii) the first text message is to be displayed in a chronological order along with messages between the message sender and the message recipient.

11. A method for sending a message with an anchor, comprising:
sending a first text message from a message sender in a chat room between the message sender and a message recipient on a mobile application executing on a smartphone associated with the message sender;
detecting a first anchoring user input, from the message sender with respect to the first text message to be sent, indicating that the first text message is to be anchored after being sent;
anchoring the first text message such that the first text message is displayed on a display screen of the smartphone in response to the message sender selecting the chat room between the message sender and the message recipient from a list of chat rooms on the mobile application;
in response to detecting a first selecting user input from the message sender selecting the chat room with the message sender and the message recipient from the list of chat rooms on the mobile application, causing the first text message to be displayed on a region of the display screen, and
in response to detecting a subsequent user input from the message sender subsequent to the first selecting user input, causing (i) the first text message to be removed from the region of the display screen and (ii) at least a portion of another text message between the message sender and the message recipient to be displayed in the region of the display screen from the first text message was removed.

12. The method according to claim 11, wherein the first anchoring user input indicating that the first text message is to be anchored comprises tapping on the text message and selecting ‘anchor’ from a dropdown menu, performing a long press on the text message, swiping in a direction on the text message, and double tapping on the text message.

13. The method according to claim 11, wherein the subsequent user input from the message sender subsequent to the first selecting user input comprises scrolling up and/or down, tapping an input field, and typing.

14. The method according to claim 11 further comprises storing anchoring data associated with the first text message.

15. The method according to claim 14, wherein causing the text message to be displayed on the region of the display screen further comprises:
retrieving the anchoring data associated with the first text message, and
displaying the text message on the region of the display screen of the display screen.

16. The method according to claim 11 further comprises:
detecting a second anchoring user input from the message sender with respect to a second text message indicating that the second text message is to be anchored, wherein the second text message is either received from the message sender or sent by the message sender, and
anchoring the second text message such that the second text message is displayed on the display screen of the smartphone,
wherein anchoring the second text message comprising, when the chat room between the message sender and the message recipient is open on the mobile application, causing the second text message to be displayed on a second region of the display screen.

17. The method according to claim 11, further comprises:
detecting an application-wide anchoring user input from the message sender with respect to the first text message indicating that the first text message is to be anchored when any of the list of chat rooms on the mobile application is selected, and
in response to detecting an application-wide selecting user input from the message sender selecting any chat room from the list of chat rooms on the mobile application, causing the text message to be displayed on the region of the display screen.

18. The method according to claim 11, further comprises:
detecting a moving user input from the message sender indicating that the first text message is to be moved to a second chat room and be anchored in the second chat room, wherein the second chat room comprises any chat room between the message sender and others not including the message recipient,
in response to detecting a second selecting user input from the message sender selecting the second chat room from the list of chat rooms on the mobile application, causing the text message to be displayed on the region of the display screen, and
removing the text message from the region of the display screen when the chat room between the message sender and the message recipient is selected.

19. The method according to claim 11, further comprising:
detecting a removing user input from the message sender indicating that the first text message is to be removed from being anchored, and
in response to the removing user input, causing (i) the first text message to be removed from the region of the display screen, (ii) at least the portion of another text message between the message sender and the message recipient to be displayed in the region of the display screen from the first text message was removed, and (iii) the first text message is to be displayed in a chronological order along with messages between the message sender and the message recipient.

20. A system for anchoring a received message, comprising:
a sender device associated with a message sender;
a recipient device associated with a message recipient, configured at least to:
receive a first text message from a message sender in a chat room between the message sender and the message recipient on a mobile application executing on the device associated with the message recipient;
detect a first anchoring user input from the message recipient with respect to the first text message indicating that the first text message is to be anchored;
anchor the first text message such that the first text message is displayed on a display screen of the device in response to the message recipient selecting the chat room between the message sender and the message recipient from a list of chat rooms on the mobile application;
in response to detecting a first selecting user input from the message recipient selecting the chat room with the message sender and the message recipient from the list of chat rooms on the mobile application, cause the first text message to be displayed on a region of the display screen; and
in response to detecting a subsequent user input from the message recipient subsequent to the first selecting user input, cause (i) the first text message to be removed from the region of the display screen and (ii) at least a portion of another text message between the message sender and the message recipient to be displayed in the region of the display screen from the first text message was removed.
